(19) United States
(12) Patent Application Publication
(10) Pub. No.: US 2015/0022722 A1
(43) Pub. Date: Jan. 22, 2015

(54) INTEGRATED COMPUTER, COMPUTER SYSTEM AND INPUT/OUTPUT SIGNAL AUTOMATIC DETECTING METHOD FOR THE INTEGRATED COMPUTER

(71) Applicant: Elitegroup Computer Systems Co., Ltd., Taipei City (TW)

(72) Inventors: Ming-Lun Yang, Taipei City (TW); Shang-Chieh Chen, Taipei City (TW)

(73) Assignee: Elitegroup Computer Systems Co., Ltd., Taipei City (TW)

(21) Appl. No.: 14/264,065

(22) Filed: Apr. 29, 2014

Related U.S. Application Data
(60) Provisional application No. 61/857,226, filed on Jul. 22, 2013.

(51) Int. Cl. H04N 5/268

(52) U.S. Cl. CPC H04N 5/268
USPC 348/705

(57) ABSTRACT

An integrated computer, a computer system and an input/output signal automatic detecting method for the integrated computer are provided. After a signal terminal is inserted into a socket of the integrated computer, the integrated computer will detect if an external video signal can be received and then set the integrated computer in an input mode or an output mode accordingly. In the input mode, a display of the integrated computer will display images according to the external video signal. In the output mode, a graphic processor unit (GPU) of the integrated computer will provide a first internal video signal to the display and a second internal video signal to a display device coupled to the signal terminal.

### CROSS REFERENCE TO RELATED APPLICATIONS

This application claims the benefit of U.S. Provisional Application No. 61/857,226, filed on Jul. 22, 2013, the contents of which are incorporated herein by reference.

### BACKGROUND OF THE INVENTION

1. Field of the Invention

The present invention is related to an integrated computer, a computer system and an input/output signal automatic detecting method for the integrated computer, and more particularly, to an input/output signal automatic detecting method in that an automatic determination is performed for setting the integrated computer to an input mode or an output mode after a signal terminal is inserted to the integrated computer.

2. Description of the Prior Art

With the increasing demand of life quality and aesthetic desire and rapid development of electronic technology, computer manufacturers are working toward integrating a computer case with a display to develop a more compact computer system such as an all-in-one (AIO) computer, personal digital assistant (PDA), tablet computer, laptop and smartphone, etc. These light and handy computer systems are becoming more and more popular. An integrated computer usually looks like a simple display, but all functional components of a computer has been integrated into it, hence a user can just connect the I/O device such as a keyboard, a microphone and/or a mouse to the integrated computer instead of connecting to a clumsy computer case.

However, when connecting another electronic device to an integrated computer, if the integrated computer can be switched to an input mode or an output mode, being set as a specific mode could be a problem. For example, when connecting a laptop to an AIO desktop computer via a signal terminal, the laptop is used as a host, and the AIO desktop computer is used as a display, a user needs to set the AIO desktop computer to an input mode manually so as to receive an external video signal from the laptop.

In another example, when connecting a display device (such as an LCD monitor) to a AIO desktop computer via a signal terminal so as to have the effect of “dual-display” on the display device and the display of the AIO desktop computer, a user needs to set the AIO desktop computer to an output mode manually so that the AIO desktop computer can output a video signal to the external display device.

To avoid the manual setting mentioned above, an input port and an output port can be disposed separately to separate the input path from the output path, and the manual setting for switching the input/output mode is no more needed. However, having two ports instead of a single port increases the volume and complexity of the I/O interface, reduces the functional flexibility of the integrated computer, and is disadvantageous to the product specification.

It is common to interconnect different electronic devices for various purposes, hence a solution is required in the field of consumer electronics to solve the problem of setting input/output mode of an integrated computer when connecting the integrated computer with another electronic device.

### SUMMARY OF THE INVENTION

The present invention discloses an integrated computer, and the integrated computer comprises a display and a main body comprising a video signal circuit board. The video signal circuit board comprises a graphic processor unit (GPU), a socket, a switch, a scalar, and an embedded controller. The GPU is configured to generate and output a first internal video signal and a second internal video signal. The socket is configured to receive an external video signal or output the second internal video signal via a signal terminal, and generate and output an insertion notification signal when the signal terminal is inserted to the socket. The switch is configured to be set to an input mode when receiving a socket insertion mode conversion signal, and receive and then output the second internal video signal when receiving an output mode conversion signal and being set to an output mode accordingly. The scalar is configured to determine if the external video signal is received when receiving the socket insertion mode conversion signal and being set to an input determination mode accordingly, and output a determination signal when determining that the scalar has not received the external video signal; determine if the external video signal is received when receiving the socket insertion mode conversion signal and being set to the input determination mode accordingly, and set the scalar to the input mode and output an adjusted external video signal when determining that the scalar has received the external video signal; and receive and adjust the first internal video signal so as to generate and output an adjusted first internal video signal when receiving the output mode conversion signal and being set to the output mode accordingly. The embedded controller is configured to generate and output the socket insertion mode conversion signal to the switch and the scalar when receiving the insertion notification signal; and generate and output the output mode conversion signal to the switch and the scalar according to a level of the determination signal when receiving the determination signal. The display is configured to display a frame according to the adjusted external video signal or the adjusted first internal video signal. When the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode.

The present invention further discloses a computer system comprising a display device, a signal terminal, and an integrated computer. The display device is configured to display a second frame according to a second internal video signal. The signal terminal is coupled to the display device. The integrated computer comprises a display and a main body comprising a video signal circuit board. The video signal circuit board comprises a graphic processor unit (GPU), a socket, a switch, a scalar, and an embedded controller. The GPU is configured to generate and output a first internal video signal and the second internal video signal. The socket is configured to receive an external video signal or output the second internal video signal via the signal terminal, and generate and output an insertion notification signal when the signal terminal is inserted to the socket. The switch is configured to be set to an input mode when receiving a socket insertion mode conversion signal, and receive and then output the second internal video signal when receiving an output mode conversion signal and being set to an output mode accordingly. The scalar is configured to determine if the external video signal is received when receiving the socket insertion mode conversion signal and being set to an input determination mode accordingly, and output a determination signal when determining that the scalar has not received the external video signal; determine if the external video signal is received when receiving the socket insertion mode conversion signal and being set to the input determination mode accordingly, and set the scalar to the input mode and output an adjusted external video signal when determining that the scalar has received the external video signal; and receive and adjust the first internal video signal so as to generate and output an adjusted first internal video signal when receiving the output mode conversion signal and being set to the output mode accordingly. The embedded controller is configured to generate and output the socket insertion mode conversion signal to the switch and the scalar when receiving the insertion notification signal; and generate and output the output mode conversion signal to the switch and the scalar according to a level of the determination signal when receiving the determination signal. The display is configured to display a first frame according to the adjusted external video signal or the adjusted first internal video signal. When the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode; after the scalar is set to the input determination mode, if the scalar has not received the external video signal within a predetermined time period, the scalar outputs a determination signal to the embedded controller, and the embedded controller outputs the output mode conversion signal to the switch and the scalar according to the level of the determination signal so as to set the switch and the scalar to the output mode.

The present invention further discloses a computer system comprising an external video signal source, a signal terminal and an integrated computer. The external video signal source is configured to output an external video signal. The signal terminal is coupled to the external video signal source. The integrated computer comprises a display and a main body comprising a video signal circuit board. The video signal circuit board comprises a graphic processor unit (GPU), a socket, a switch, a scalar, and an embedded controller. The GPU is configured to generate and output a first internal video signal and a second internal video signal. The socket is configured to receive the external video signal or output the second internal video signal via the signal terminal, and generate and output an insertion notification signal when the signal terminal is inserted to the socket. The switch is configured to be set to an input mode when receiving a socket insertion mode conversion signal, and receive and then output the second internal video signal when receiving an output mode conversion signal and being set to an output mode accordingly. The scalar is configured to determine if the external video signal is received when receiving the socket insertion mode conversion signal and being set to an input determination mode accordingly, and output a determination signal when determining that the scalar has not received the external video signal; determine if the external video signal is received when receiving the socket insertion mode conversion signal and being set to the input determination mode accordingly, and set the scalar to the input mode and output an adjusted external video signal when determining that the scalar has received the external video signal; and receive and adjust the first internal video signal so as to generate and output an adjusted first internal video signal when receiving the output mode conversion signal and being set to the output mode accordingly. The embedded controller is configured to generate and output the socket insertion mode conversion signal to the switch and the scalar when receiving the insertion notification signal; and generate and output the output mode conversion signal to the switch and the scalar according to a level of the determination signal when receiving the determination signal. The display is configured to display a frame according to the adjusted external video signal or the adjusted first internal video signal. When the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode; after the scalar is set to the input determination mode, if the scalar has received the external video signal within a predetermined time period, the scalar is set to the input mode so as to generate and output the adjusted external video signal.

The present invention further discloses an input/output signal automatic detecting method for an integrated computer. The integrated computer comprises a video signal circuit board, and the video signal circuit board comprises a socket, a switch, a scalar and an embedded controller. The method comprises that the socket outputting an insertion notification signal to the embedded controller after a signal terminal is inserted to the socket; and the embedded controller outputting a socket insertion mode conversion signal to the switch and the scalar according to the insertion notification signal so as to set the switch to an input mode and set the scalar to an input determination mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an integrated computer according to an embodiment of the present invention.

FIG. 2 is a diagram illustrating a computer system with an integrated computer in an output mode according to an embodiment of the present invention.

FIG. 3 is a diagram illustrating a computer system with an integrated computer in an input mode according to an embodiment of the present invention.

FIG. 4 is a flowchart illustrating an input/output signal automatic detecting method according to an embodiment of the present invention.

### DETAILED DESCRIPTION

An integrated computer, a computer system and an input/output signal automatic detecting method for the integrated computer are introduced in detail hereinafter with exemplary embodiments and illustrations, but the present invention is not limited to the provided embodiments.

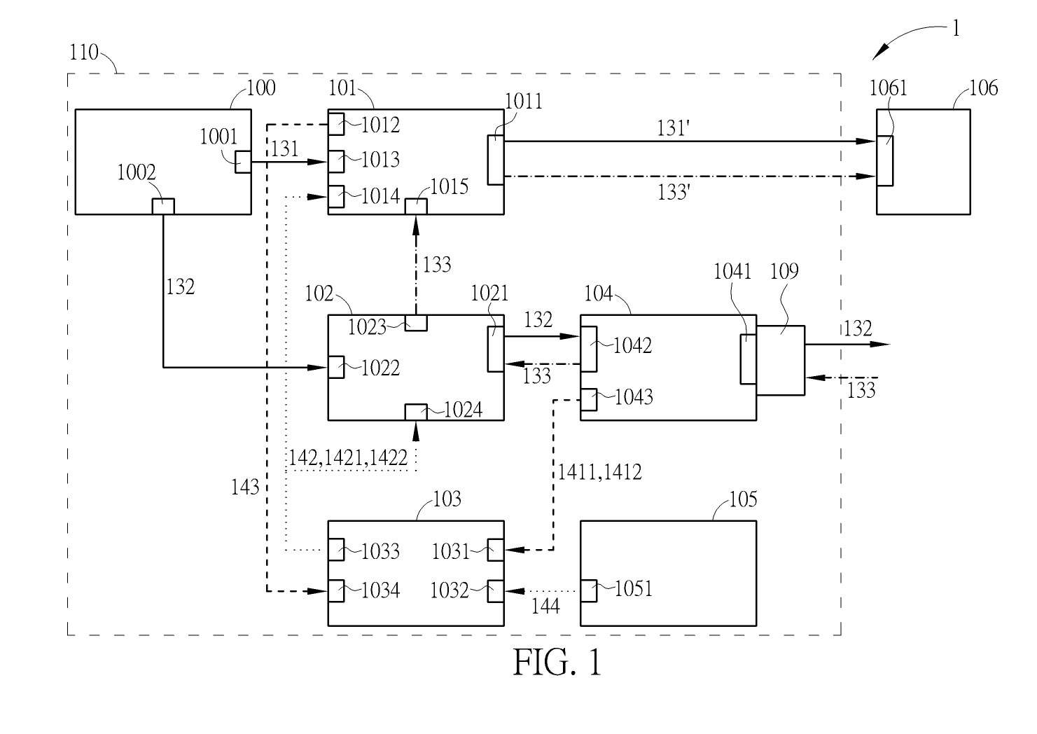

Please refer to FIG. 1. FIG. 1 is a diagram illustrating an integrated computer 1 according to an embodiment of the present invention. As shown in FIG. 1, the integrated computer 1 comprises a display 106 and a video signal circuit board 110. The video signal circuit board 110 comprises a graphic processor unit (GPU) 100, a scalar 101, a switch 102, an embedded controller 103, a socket 104 and a mode selection interface 105.

The display 106 is configured to display a frame according to an adjusted external video signal 133′ or an adjusted first internal video signal 131′. The display 106 comprises a receiving node 1061 configured to receive the adjusted external video signal 133′ or the adjusted first internal video signal 131′. The GPU 100 comprises a first node 1001 and a second node 1002, and is configured to generate and output a first internal video signal 131 and a second internal video signal 132 via the first node 1001 and the second node 1002, respectively. The socket 104 comprises a first node 1041 configured to receive an external video signal 133 or output the second internal video signal 132 via a signal terminal 109, a second node 1042 configured to receive the second internal video signal 132 or output the external video signal 133, and a third node 1043 configured to output an insertion notification signal 1411 or a pull-out notification signal 1412 when the signal terminal 109 is inserted to or pulled out from the socket 104 respectively. The switch 102 is configured to control the transmission of the external video signal 133 and the second internal video signal 132 according to a socket insertion mode conversion signal 142, an input mode conversion signal 1421 and an output mode conversion signal 1422. The switch 102 comprises a first node 1021 coupled to the second node 1042 of the socket 104 and configured to output the second internal video signal 132 to the second node 1042 of the socket 104 or receive the external video signal 133 from the second node 1042 of the socket 104, a second node 1022 coupled to the second node 1002 of the GPU 100 and configured to receive the second internal video signal 132, a third node 1023 configured to output the external video signal 133 received via the first node 1021 of the switch 102, and a fourth node 1024 configured to receive the socket insertion mode conversion signal 142, the input mode conversion signal 1421 and the output mode conversion signal 1422. The scalar 101 is configured to adjust the first internal video signal 131 for generating the adjusted first internal video signal 131′, or adjust the external video signal 133 for generating the adjusted external video signal 133′. The scalar 101 comprises a first node 1011, a second node 1012, a third node 1013, a fourth node 1014 and a fifth node 1015. The first node 1011 of the scalar 101 is coupled to the receiving node 1061 of the display 106 and configured to output the adjusted first internal video signal 131′ or the adjusted external video signal 133′ to the display 106. The second node 1012 of the scalar 101 is configured to output a determination signal 143. The third node 1013 of the scalar 101 is coupled to the first node 1001 of the GPU 100 and configured to receive the first internal video signal 131. The fourth node 1014 of the scalar 101 is configured to receive the socket insertion mode conversion signal 142, the input mode conversion signal 1421 and the output mode conversion signal 1422. The fifth node 1015 of the scalar 101 is coupled to the third node 1023 of the switch 102 and configured to receive the external video signal 133. The embedded controller 103 is configured to generate the socket insertion mode conversion signal 142, the input mode conversion signal 1421 and the output mode conversion signal 1422 according to the insertion notification signal 1411, the pull-out notification signal 1412, the determination signal 143 and a manual mode signal 144. The embedded controller 103 comprises a first node 1031, a second node 1032, a third node 1033 and a fourth node 1034. The first node 1031 of the embedded controller 103 is coupled to the third node 1043 of the socket 104 and configured to receive the insertion notification signal 1411 and the pull-out notification signal 1412. The second node 1032 of the embedded controller 103 is configured to receive the manual mode signal 144. The third node 1033 of the embedded controller 103 is coupled to the fourth node 1024 of the switch 1024 and the fourth node 1014 of the scalar 101 and configured to output the socket insertion mode conversion signal 142, the input mode conversion signal 1421 and the output mode conversion signal 1422 to the fourth node 1014 of the scalar 101 and the fourth node 1024 of the switch 102. The fourth node 1034 of the embedded controller 103 is coupled to the second node 1012 of the scalar 101 and configured to receive the determination signal 143. The mode selection interface 105 is configured to generate the manual mode signal 144 according to an input instruction. The mode selection interface 105 comprises an output node 1051 configured to output the manual mode signal 144. When the signal terminal 109 is inserted to the first node 1041 of the socket 104, the socket 104 outputs the insertion notification signal 1411 to the embedded controller 103, and the embedded controller 103 outputs the socket insertion mode conversion signal 142 to the switch 102 and the scalar 101 so as to set the switch 102 to an input mode and set the scalar 101 to an input determination mode. The signal terminal 109 is not a part of the integrated computer 1 but a device configured to be inserted to or pulled out from the socket 104, and the signal terminal 109 is mentioned to help to describe the function of the socket 104.

As shown in FIG. 1, when the signal terminal 109 has not been inserted to the socket 104 of the integrated computer 1, the integrated computer 1 is not connected to any electronic device, such as a laptop or a liquid crystal display via the signal terminal 109, hence the display 106 of the integrated computer 1 displays a frame according to the adjusted first internal video signal 131′ that is generated by the GPU 100 and then adjusted by the scalar 101. At this condition, the scalar 101 is set to the output mode. After the GPU 100 generates the first internal video signal 131, the first internal video signal 131 is transmitted to the scalar 101 and adjusted by the scalar 101, and the adjusted first internal video signal 131′ is outputted to the receiving node 1061 of the display 106.

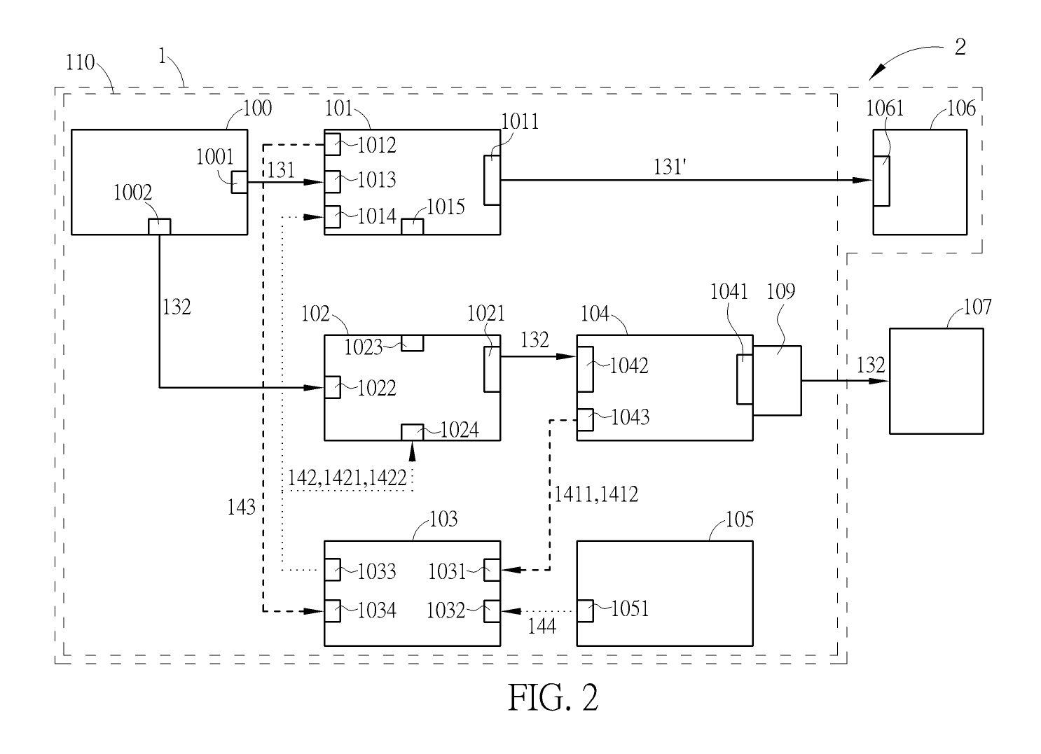

Please refer to FIG. 2 which is a diagram illustrating a computer system 2 with an integrated computer in the output mode according to an embodiment of the present invention. The computer system 2 comprises a display device 107, the signal terminal 109 and the abovementioned integrated computer 1. The display device 107 displays a frame according to the second internal video signal 132, and the signal terminal 109 is coupled to the display device 107. The relationships of connections between the nodes of the components of the integrated computer 1 have been introduced in detail above and are not described repeatedly.

When the signal terminal 109 is inserted to the first node 1041 of the socket 104, the socket 104 outputs the insertion notification signal 1411 to the embedded controller 103. The embedded controller 103 outputs the socket insertion mode conversion signal 142 to the switch 102 and the scalar 101 according to the insertion notification signal 1411 so as to set the switch 102 to the input mode and set the scalar 101 to the input determination mode. After a predetermined time period, if the scalar 101 has not received the external video signal 133, the scalar 101 outputs the determination signal 143 to the embedded controller 103 according to the result of waiting, and the embedded controller 103 generates the output mode conversion signal 1422 according to a level of the determination signal 143 and outputs the output mode conversion signal 1422 to the switch 102 and the scalar 101 so as to set both of the switch 102 and the scalar 101 to the output mode and allow the switch 102 to receive and output the second internal video signal 132. When the switch 102 and the scalar 101 are set to the output mode, the GPU 100 outputs the first internal video signal 131 to the scalar 101 and the second internal video signal 132 to the switch 102. After the scalar 101 has received the first internal video signal 131, the scalar 101 adjusts the first internal video signal 131 so as to generate the adjusted first internal video signal 131′. After the scalar 101 has generated the adjusted first internal video signal 131′, the scalar 101 outputs the adjusted first internal video signal 131′ to the display 106. After the switch 102 has received the second internal video signal 132, the switch 102 outputs the second internal video signal 132 to the socket 104. After the socket 104 has received the second internal video signal 132, the socket 104 outputs the second internal video signal 132 to the display device 107 via the signal terminal 109.

According to the description above, after the signal terminal 109 is inserted to the socket 104, an automatic detecting mechanism described above can be used to determine that the display device 107 instead of an external video signal source providing the external video signal 133 is coupled to the integrated computer 1 via the signal terminal 109. The switch 102 and the scalar 101 are set to the output mode automatically. The display 106 of the integrated computer 1 receives the adjusted first internal video signal 131′ generated by the GPU 100 and adjusted by the scalar 101 and displays a first frame according to the adjusted first internal video signal 131′. The display device 107 coupled to the integrated computer 1 via the signal terminal 109 displays a second frame according to the second internal video signal 132. Because the GPU 100 may integrate the first internal video signal 131 and the second internal video signal 132 after processing, the first frame (displayed according to the adjusted first internal video signal 131′) and the second frame (displayed according to the second internal video signal 132) may be a left part and a right part of an image respectively, or be two different images. In this way, a user can use the effect of “dual-display” on two displays (for example, the display 106 and the display device 107) without manually setting the integrated computer 1 to the output mode. After the user inserts the signal terminal 109 (coupled to the display device 107) to the socket 104, the integrated computer 1 is then set to the output mode automatically, and the effect of dual-display is generated automatically. The display device 107 may be a liquid crystal display, a plasma display (LCD), a cathode ray tube (CRT) display or a light-emitting diode (LED) display. The signal terminal 109 may be a high definition multimedia interface (HDMI) terminal, a digital video interface (DVI) terminal, a DisplayPort terminal or a video graphics array (VGA) terminal.

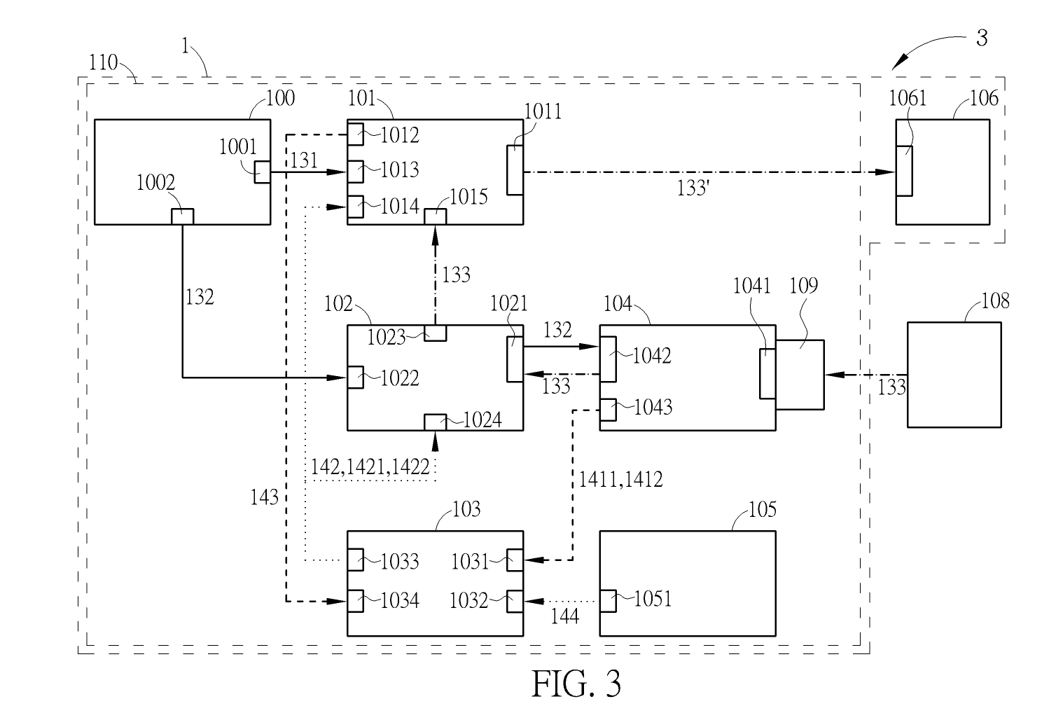

Please refer to FIG. 3 that is a diagram illustrating a computer system 3 with an integrated computer 1 in the input mode according to an embodiment of the present invention. The computer system 3 comprises an external video signal source 108, the signal terminal 109 and the integrated computer 1 described above. The external video signal source 108 is configured to output the external video signals 133. The signal terminal 109 is coupled to the external video signal source 108. The relationships of connections between the nodes of the components of the integrated computer 1 have been introduced in detail above and are not described repeatedly.

When the signal terminal 109 is inserted to the first node 1041 of the socket 104, the socket 104 outputs the insertion notification signal 1411 to the embedded controller 103, and then the embedded controller 103 outputs the socket insertion mode conversion signal 142 to the scalar 101 and the switch 102 to set the scalar 101 to the input determination mode and set the switch 102 to the input mode respectively. After the scalar 101 and the switch 102 are set to the input determination mode and the input mode respectively, the external video signal 133 outputted from the external video signal source 108 is allowed to be transmitted to the socket 104 via the signal terminal 109. After the socket 104 has received the external video signal 133, the socket 104 outputs the external video signal 133 to the switch 102. After the switch 102 has received the external video signal 133, the switch 102 outputs the external video signal 133 to the scalar 101. After the scalar 101 has received the external video signal 133, the scalar 101 is set to the input mode and adjusts the external video signal 133 for generating the adjusted external video signal 133′. For example, the scalar 101 is set to the input mode by the scalar 101 itself automatically if the scalar 101 has received the external video signal 133 within a predetermined time period. After the scalar 101 has generated the adjusted external video signal 133′, the scalar 101 outputs the adjusted external video signal 133′ to the display 106.

According to the description above, after the signal terminal 109 is inserted to the socket 104, the automatic detecting mechanism described above can be used to determine that the external video signal source 108 instead of the display device 107 is coupled to the integrated computer 1 via the signal terminal 109. The switch 102 and the scalar 101 are set to the input mode automatically. At this condition, the display 106 of the integrated computer 1 receives the adjusted external video signal 133′ that is generated by the external video signal source 108 and adjusted by the scalar 101 so as to display a frame. The external video signal source 108 may be a laptop, a desktop computer, an industrial computer, a tablet computer, or a video disc player such as a Blu-ray Disc player or a DVD player. A user may just couple the external video signal source 108 to the integrated computer 1 by inserting the signal terminal 109 (such as an HDMI terminal, a DVI terminal, a DisplayPort terminal or a VGA terminal) to the socket 104, and then the integrated computer 1 works as a display for displaying a video or as a computer monitor. Similarly, as the output mode introduced above, manual setting for setting the integrated computer to the output mode is unnecessary. After the signal terminal 109 coupled to the external video signal source 108 has been inserted to the socket 104, the display 106 can display correct images without manual setting.

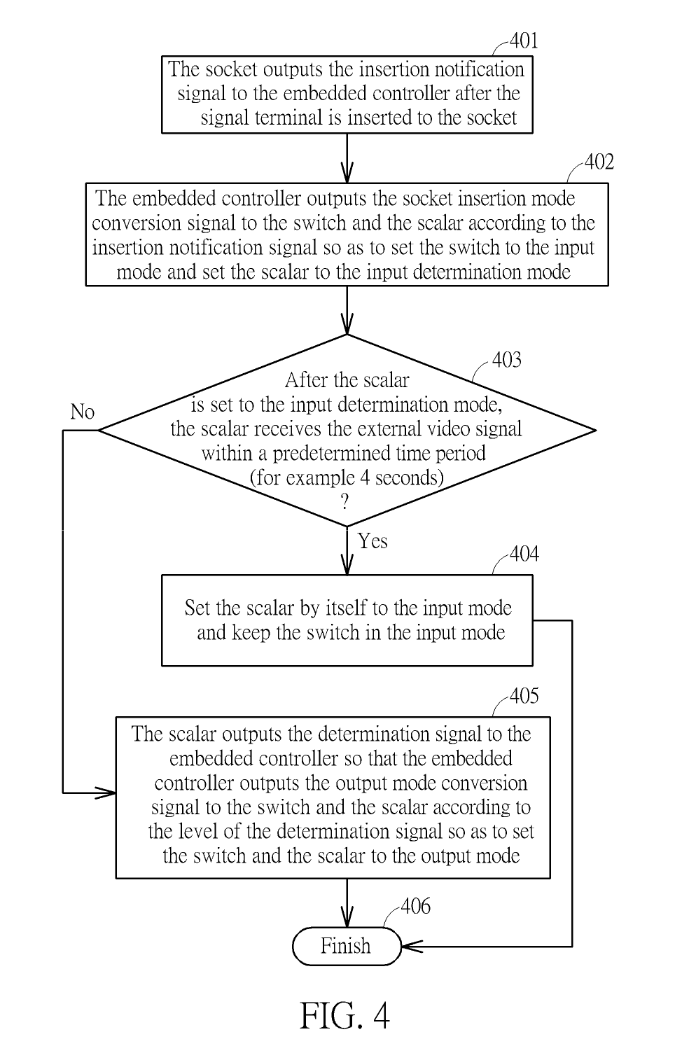

Please refer to FIG. 4 showing a flowchart illustrating an input/output signal automatic detecting method according to an embodiment of the present invention. The method comprises the following steps:

Step 401: the socket 104 outputs the insertion notification signal 1411 to the embedded controller 103 after the signal terminal 109 is inserted to the socket 104;

Step 402: the embedded controller 103 outputs the socket insertion mode conversion signal 142 to the switch 102 and the scalar 101 according to the insertion notification signal 1411 so as to set the switch 102 to the input mode and set the scalar 101 to the input determination mode;

Step 403: after the scalar 101 is set to the input determination mode, if the scalar 101 receives the external video signal 133 within a predetermined time period (for example 4 seconds), go to step 404, otherwise, go to step 405;

Step 404: set the scalar 101 by itself to the input mode and keep the switch 102 in the input mode; go to step 406;

Step 405: the scalar 101 outputs the determination signal 143 to the embedded controller 103 so that the embedded controller 103 outputs the output mode conversion signal 1422 to the switch 102 and the scalar 101 according to the level of the determination signal 143 so as to set the switch 102 and the scalar 101 to the output mode;

Step 406: finish

According to the flowchart of the method shown in FIG. 4, after the signal terminal 109 is inserted to the socket 104, the switch 102 and the scalar 101 are determined to be set to the input mode or the output mode automatically with the input/output signal automatic detecting method of the present invention, which saves troubles in manually setting the input mode or the output mode by users.

When the signal terminal 109 is pulled out of the socket 104, the socket 104 generates and outputs the pull-out notification signal 1412 to the embedded controller 103. After the embedded controller 103 receives the pull-out notification signal 1412, the embedded controller 103 generates and outputs the output mode conversion signal 1422 to the switch 102 and the scalar 101 so as to set the switch 102 and the scalar 101 to the output mode. The first internal video signal 131 generated by the GPU 100 is outputted to the scalar 101 and then adjusted by the scalar 101, and then the adjusted first internal video signal 131′ is outputted to the display 106 for displaying images. In other words, after the signal terminal 109 is pulled out of the socket 104, the integrated computer 1 is set to the output mode automatically without manual setting and able to display correctly according to the adjusted first internal video signal 131′ generated by the GPU 100.

As shown in FIG. 1, FIG. 2 and FIG. 3, the integrated computer 1 described above further comprises the mode selection interface 105. For a user who would like to set the integrated computer 1 to the input mode or the output mode manually, the user is allowed to input an input instruction to the mode selection interface 105, and then the mode selection interface 105 outputs the manual mode signal 144 to the embedded controller 103 accordingly. The embedded controller 103 then generates and outputs the input mode conversion signal 1421 or the output mode conversion signal 1422 so as to set the switch 102 and the scalar 101 to the input mode or the output mode according to the manual mode signal 144. The mentioned mode selection interface 105 maybe a button, a toggle switch, a slide switch, a GUI (graphical user interface), and/or a voice control interface. In another embodiment of the present invention, the mode selection interface 105 can be omitted in the integrated computer 1, hence it is not allowed to set the integrated computer to the input mode or the output mode manually.

According to the embodiments of the present invention, the integrated computer 1 mentioned above may be variant household, handheld or portable electronic devices such as an AIO (All-In-One) computer, a PDA (Personal Digital Assistant), a tablet computer, a laptop or a smartphone. If a display (e.g. an LCD display) is integrated with a video signal circuit board which controls, transmits and receives video signals in an electronic device, the electronic device can be classified as the mentioned integrated computer. According to another embodiment of the present invention, the mentioned video signal circuit board may be a circuit board which only receives, outputs and processes video signals. The mentioned video signal circuit board may further be a circuit board integrated with some other electronic components with other functions, for example, a mainboard. Furthermore, according to another embodiment of the present invention, the mentioned video signal circuit board is substantially comprised by a main body of the integrated computer. The said main body is other part of an integrated computer (that is an electronic device comprising a display and a video signal circuit board such as a mainboard, for example, an AIO desktop computer, a PDA, a tablet computer, a laptop or a smartphone) except the display of the integrated computer. For example, the said main body may be other parts of a laptop except the display of the laptop, and comprises the mainboard, the hard disk, the RAM, the case, the I/O device and/or the speakers of the laptop. The main body and the display of the integrated computer are integrated together, and the display may be configured to be on a surface of the main body. Some components of the main body are allowed to be integrated in an IC chip according to the required specification and the technical ability of the manufacturer. Hence, some or all of the mentioned components of the video signal circuit board, for example, the scalar, the embedded controller, the mode selection interface, the socket, the switch and the GPU may be integrated into a single IC chip according to the required specification and the technical ability of the manufacturer.

In summary, according to an embodiment of the present invention, when another electronic device such as a laptop or an LCD monitor is coupled to an integrated computer, it is automatically determined if an external video signal is received by the integrated computer, and the integrated computer is then set to an input mode or an output mode accordingly. Hence, the present invention can help users to avoid the inconvenience of manual setting, and also allow the integrated computer to have a single port socket instead of separating the socket as an input port and an output port. For user experience, and competitiveness and flexibility of the product specification, the present invention is beneficial.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated computer, comprising
a main body comprising a video signal circuit board, the video signal circuit board comprising:
a graphic processor unit (GPU) configured to generate and output a first internal video signal and a second internal video signal;
a socket configured to receive an external video signal or output the second internal video signal via a signal terminal, and generate and output an insertion notification signal when the signal terminal is inserted to the socket;
a switch configured to be set to an input mode when receiving a socket insertion mode conversion signal and receive and then output the second internal video signal when receiving an output mode conversion signal and being set to an output mode accordingly;
a scalar configured to:
determine if the external video signal is received when receiving the socket insertion mode conversion signal and being set to an input determination mode accordingly, and output a determination signal when determining that the scalar has not received the external video signal;
determine if the external video signal is received when receiving the socket insertion mode conversion signal and being set to the input determination mode accordingly, and set the scalar to the input mode and output an adjusted external video signal when determining that the scalar has received the external video signal; and
receive and adjust the first internal video signal so as to generate and output an adjusted first internal video signal when receiving the output mode conversion signal and being set to the output mode accordingly; and
an embedded controller configured to:
generate and output the socket insertion mode conversion signal to the switch and the scalar when receiving the insertion notification signal; and
generate and output the output mode conversion signal to the switch and the scalar according to a level of the determination signal when receiving the determination signal; and
a display configured to display a frame according to the adjusted external video signal or the adjusted first internal video signal;
wherein when the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode.

2. The integrated computer of claim 1, wherein after the scalar receives the socket insertion mode conversion signal, if the scalar has not received the external video signal within a predetermined time period, the scalar outputs the determination signal to the embedded controller, and the embedded controller outputs the output mode conversion signal to the switch and the scalar so as to set the switch and the scalar to the output mode according to the level of the determination signal.

3. The integrated computer of claim 1, wherein after the scalar receives the socket insertion mode conversion signal, if the scalar has received the external video signal within a predetermined time period, the scalar is set to the input mode.

4. The integrated computer of claim 1, wherein:
when the signal terminal is pulled out of the socket, the socket generates and outputs a pull-out notification signal to the embedded controller; after the embedded controller receives the pull-out notification signal, the embedded controller generates and outputs the output mode conversion signal to the switch and the scalar so as to set the switch and the scalar to the output mode.

5. The integrated computer of claim 1, wherein:
the signal terminal is an HDMI (high definition multimedia interface) terminal, a DVI (digital video interface) terminal, a DisplayPort terminal or a VGA (video graphics array) terminal.

6. The integrated computer of claim 1, wherein:
the video signal circuit board further comprises a mode selection interface configured to receive an input instruction so as to generate a manual mode signal;
the embedded controller receives the manual mode signal and generate an input mode conversion signal or the output mode conversion signal accordingly;
the scalar is set as the input mode after receiving the input mode conversion signal; and
the switch is set as the input mode after receiving the input mode conversion signal.

7. The integrated computer of claim 6, wherein the mode selection interface comprises a button, a toggle switch, a slide switch, a GUI (graphical user interface), and/or a voice control interface.

8. A computer system, comprising
a display device configured to display a second frame according to a second internal video signal;
a signal terminal coupled to the display device; and
an integrated computer comprising:
a main body comprising a video signal circuit board, the video signal circuit board comprising:
a graphic processor unit (GPU) configured to generate and output a first internal video signal and the second internal video signal;
a socket configured to receive an external video signal or output the second internal video signal via the signal terminal, and generate and output an insertion notification signal when the signal terminal is inserted to the socket;
a switch configured to:
be set to an input mode when receiving a socket insertion mode conversion signal;
receive and then output the second internal video signal when receiving an output mode conversion signal and being set to an output mode accordingly;
a scalar configured to:
determine if the external video signal is received when receiving the socket insertion mode conversion signal and being set to an input determination mode accordingly, and output a determination signal when determining that the scalar has not received the external video signal;
determine if the external video signal is received when receiving the socket insertion mode conversion signal and being set to the input determination mode accordingly, and set the scalar to the input mode and output an adjusted external video signal when determining that the scalar has received the external video signal; and
receive and adjust the first internal video signal so as to generate and output an adjusted first internal video signal when receiving the output mode conversion signal and being set to the output mode accordingly; and
an embedded controller configured to:
generate and output the socket insertion mode conversion signal to the switch and the scalar when receiving the insertion notification signal;
generate and output the output mode conversion signal to the switch and the scalar according to a level of the determination signal when receiving the determination signal; and
a display configured to display a first frame according to the adjusted external video signal or the adjusted first internal video signal;
wherein when the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode; after the scalar is set to the input determination mode, if the scalar has not received the external video signal within a predetermined time period, the scalar outputs a determination signal to the embedded controller, and the embedded controller outputs the output mode conversion signal to the switch and the scalar according to the level of the determination signal so as to set the switch and the scalar to the output mode.

9. The computer system of claim 8, wherein:
the display device is a liquid crystal display, a plasma display, a cathode ray tube display or a light-emitting diode display.

10. A computer system, comprising
an external video signal source configured to output an external video signal;
a signal terminal coupled to the external video signal source; and
an integrated computer comprising:
a main body comprising a video signal circuit board, the video signal circuit board comprising:
a graphic processor unit (GPU) configured to generate and output a first internal video signal and a second internal video signal;
a socket configured to receive the external video signal or output the second internal video signal via the signal terminal, and generate and output an insertion notification signal when the signal terminal is inserted to the socket;
a switch configured to:
be set to an input mode when receiving a socket insertion mode conversion signal;
receive and then output the second internal video signal when receiving an output mode conversion signal and being set to an output mode accordingly;
a scalar configured to:
determine if the external video signal is received when receiving the socket insertion mode conversion signal and being set to an input determination mode accordingly, and output a determination signal when determining that the scalar has not received the external video signal;
determine if the external video signal is received when receiving the socket insertion mode conversion signal and being set to the input determination mode accordingly, and set the scalar to the input mode and output an adjusted external video signal when determining that the scalar has received the external video signal; and
receive and adjust the first internal video signal so as to generate and output an adjusted first internal video signal when receiving the output mode conversion signal and being set to the output mode accordingly; and
an embedded controller configured to:
generate and output the socket insertion mode conversion signal to the switch and the scalar when receiving the insertion notification signal;
generate and output the output mode conversion signal to the switch and the scalar according to a level of the determination signal when receiving the determination signal; and
a display configured to display a frame according to the adjusted external video signal or the adjusted first internal video signal;
wherein when the signal terminal is inserted to the socket, the socket generates and outputs the insertion notification signal to the embedded controller, the embedded controller outputs the socket insertion mode conversion signal to the switch and the scalar according to the insertion notification signal so as to set the switch to the input mode and set the scalar to the input determination mode; after the scalar is set to the input determination mode, if the scalar has received the external video signal within a predetermined time period, the scalar is set to the input mode so as to generate and output the adjusted external video signal.

11. The computer system of claim 10, wherein the external video signal source is a laptop, a desktop computer, a smart phone, a tablet computer, a PDA (personal digital assistant) or a video player.

12. An input/output signal automatic detecting method for an integrated computer, the integrated computer comprising a video signal circuit board, the video signal circuit board comprising a socket, a switch, a scalar and an embedded controller, the method comprising:
the socket outputting an insertion notification signal to the embedded controller after a signal terminal is inserted to the socket; and
the embedded controller outputting a socket insertion mode conversion signal to the switch and the scalar according to the insertion notification signal so as to set the switch to an input mode and set the scalar to an input determination mode.

13. The method of claim 12, wherein the integrated computer further comprises a display, the method further comprising:
the socket outputting an external video signal to the switch after the socket receives the external video signal;
the switch outputting the external signal to the scalar after the switch receives the external video signal;
after the scalar is set to the input determination mode, if the scalar receives the external video signal within a predetermined time period, setting the scalar to the input mode and generating an adjusted external video signal; and
the scalar outputting the adjusted external video signal to the display for displaying a frame.

14. The method of claim 12, wherein the integrated computer further comprises a display, the video signal circuit board further comprising a graphic processor unit (GPU), the method further comprising:
the scalar outputting a determination signal to the embedded controller after the scalar is set to the input determination mode and has not received an external video signal within a predetermined time period;
the embedded controller outputting an output mode conversion signal to the switch and the scalar according to a level of the determination signal so as to set the switch and the scalar to an output mode;
the GPU outputting a first internal video signal to the scalar and a second internal video signal to the switch after the switch and the scalar are set to the output mode;
after the scalar receives the first internal video signal, the scalar adjusting the first internal video signal for generating an adjusted first internal video signal and outputting the adjusted first internal video signal to the display for displaying a first frame; and
after the switch receives the second internal video signal, the switch outputting the second internal video signal to the socket; and
after the socket receives the second internal video signal, the socket outputting the second internal video signal to a display device for displaying a second frame.

15. The method of claim 12, wherein the video signal circuit board further comprises a mode selection interface, the method further comprising:
the mode selection interface receiving an input instruction and outputting a manual mode signal to the embedded controller accordingly; and
the embedded controller receiving the manual mode signal and outputting an input mode conversion signal or an output mode conversion signal to the switch and the scalar accordingly for setting the switch and the scalar to the input mode or an output mode.
